(19) United States
(12) Patent Application Publication
(10) Pub. No.: US 2009/0216858 A1
(43) Pub. Date: Aug. 27, 2009

(54) FLOOR CONVEYOR, WITH REMOTE MAINTENANCE IN PARTICULAR

(75) Inventors: Nils-Peter Hansen, Kiel (DE); Martin Langlotz, Sparrieshoop (DE); Arne Mahler, Hamburg (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Jungheinrich Aktiengesellschaft, Hamburg (DE)

(21) Appl. No.: 12/203,578

(22) Filed: Sep. 3, 2008

(30) Foreign Application Priority Data
Sep. 4, 2007 (DE) 10 2007 043 472.5

(51) Int. Cl. G06F 15/173; G06F 13/42

(52) U.S. Cl. 709/218; 710/106

(57) ABSTRACT

A floor conveyor, with a device for the capture of operation-related data, a data memory, in which the operation-related data can be stored, and an electronic control unit, which controls the capture and the storage of the operation-related data in the data memory, characterised in that the floor conveyor has a data send/receive unit for the transmission of operation-related data from the data memory of the floor conveyor to an external data memory via a transmission link, the control unit has means for checking the availability of the transmission link, and the control unit is designed for the initiation of the data transmission from the data memory to the external data memory.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a floor conveyor with a device for the capture of operation-related data, a data memory, in which the operation-related data can be stored, and an electronic control unit, which controls the capture and the storage of the operation-related data in the data memory. The present invention is related to a floor conveyor for remote maintenance in particular.

It is known to store operation-related data in the data memory of a floor conveyor. A subsequent analysis of the operation-related data permits conclusions about the kind and the extent of the usage of the floor conveyor, for instance, about the weight of the transported loads and the distances covered therewith. On the basis of these insights, the use of the floor conveyor can be improved in different respects.

A floor conveyor with such a data storage is described in the article “Transparenz im Staplerfuhrpark” in the dedicated journal “Hebezeuge und Fördermittel” Berlin 40, 2000, 11, pp. 576 to 577, the entire contents of which is incorporated herein by reference. In this known floor conveyor, the data are logged in detail over 14 days for instance, and subsequently transmitted into a PC database via a cable connection or with the aid of a memory card. Then, the analysis of the data can take place on the PC with the aid of special software.

In addition, for analysing the data stored in the floor conveyor it is known to use a laptop, which a service technician connects to the data memory of the floor conveyor with the aid of a network cable. In this case, the analysis of the data takes place during the connection to the data memory in the floor conveyor, by immediate access to the stored data.

From “Logistik und Fördertechnik”, Nr. 5, 2006, pp. 38 and 39, it is known to perform a capture of operation data in floor conveyors, the entire contents of which is incorporated herein by reference. However, the same is provided to be stationary and not in the floor conveyor. An exchange of operation times to a higher order data processing program can take place via a board computer through a radio controlled application. From “Logistik §, Nr. 12, 1999, p 34, the entire contents of which is incorporated herein by reference, it is known to provide an automatic data transmission of an operation data logfile in the stacker by means of controlled transmission to an external memory system via radio or telephone network.

From “f+h fördern und heben 43”, 1993 Nr. 10, pp 685 and 686, the entire contents of which is incorporated herein by reference, it is known to request operation data in a cyclic manner and to store them on a memory card. The memory card is put into a stationary command station by the driver.

Starting from this, it is the objective of the present invention to provide a floor conveyor with a device for the capture of operation-related data, a data memory and an electronic control unit as well as with a remote maintenance system with such a floor conveyor, which makes less demands on the user of the floor conveyor and which provides an improved database, without restricting the availability of the floor conveyor.

### BRIEF SUMMARY OF THE INVENTION

The floor conveyor according to the present invention has a device for the capture of operation-related data, a data memory, in which the operation-related data can be stored, and an electronic control unit, which controls the capture and the storage of the operation-related data, wherein the floor conveyor has a wireless data transmission device, which transmits the operation-related data from the data memory of the floor conveyor to an external data memory, wherein the preferably wireless data transmission is initiated by the electronic control unit. The initiation is depending on whether the transmission link is available and whether data are to be transmitted. Only when this is the case, data transmission takes place, according to a preset program, for instance.

The operation-related data may be all the data which have a relation to the operation of the floor conveyor, in particular data concerning the travel operation, like for instance travel speeds, covered distances, curve radiuses and curve speeds, rotational numbers or vehicle shocks, data concerning the lifting operation of the floor conveyor, like for instance lifting heights or lifted loads, data concerning state variables of the floor conveyor, like for instance battery voltages, temperatures of oil and/or brake fluid, pressures in the hydraulic system or preset operation parameters, data concerning particular events, like for instance records in error protocols or vehicle conditions at the time of an accident, data concerning merchandise management, like for instance approached storeroom positions or transported merchandises or transportation instructions, optionally captured by the floor conveyor with the aid of a corresponding encoding, data concerning persons, like for instance driving times of a certain driver.

On the other hand, the external data memory can be requested independently from whether the vehicle is in the operation, is in the reception range and so on. In other words, there is generated a “knowledge” database for all data of interest of the vehicle, which are available at any time, independently from whether an on-line request is possible at the desired point in time or not.

The device for the capture of operation-related data can consist of separate sensors or it may use the already existing vehicle associated sensor system. Also possible is the cooperation with an existing board computer, in which operation-related data are present.

For instance, the data memory may be a flash memory, which can be integrated into the electronic control unit. The electronic control unit may be a miniature PC, for instance.

The floor conveyor has a data transmission device, preferably a wireless one, i.e. a data send/receive unit by which the operation-related data are transmitted to an external data memory from the data memory of the floor conveyor. Through this, the operation-related data are available for further analysis in the external data memory. The external data memory is independent from the data memory of the floor conveyor and permits access to the data stored in it, being independent from the actual use of the floor conveyor. In particular, it is not necessary that there is a wireless connection, for instance, or another connection to the data memory of the floor conveyor at the time of the access to the operation-related data stored in the external data memory. Through this, the analysis of the operation-related data is significantly facilitated in practice. Also, the access to the data does not have any effect on the availability of the floor conveyor.

The wireless data transmission of the operation-related data to the external data memory is initiated by the electronic control unit. Thus, the data transmission is triggered automatically by the electronic control unit. No user interaction is needed for the transmission of the data, in particular, no service technician has to produce a connection to the data memory of the floor conveyor, nor has the user of the floor conveyor to take any special measures for the data transmission. In particular, he/she has not to make a cable connection and he/she is not required to take a memory card or another memory medium out of the floor conveyor.

The initiation of a wireless data transmission can include the build-up of a radio connection, or, when there is already a radio connection, it may essentially consist of sending out the data.

In a preferred embodiment, the wireless data transmission can be performed by the electronic control unit at presettable points in time or at configurable events. For instance, the points in time may be determined by the clock time or by presettable time intervals. Such a time schedule for the data transmission results in an updated data amount in the external data memory, which permits a prompt analysis of the data. In particular, a relief of the radio network is achieved compared with a continuous data transmission. As already pointed out, a data transmission is depending on whether the transmission link enables a transmission of data, i.e. the preferably wireless data transmission from the electronic control unit is depending on the availability of a radio connection, for instance. Thus, it is taken into account by the electronic control unit whether a radio connection is available and a data transmission is possible with the required security. In particular, data transmission can be omitted when the floor conveyor is in a region with bad reception properties. Preferably, the electronic control unit checks at preset points in time whether a radio connection is possible.

In one embodiment of the present invention, the initiation of the preferably wireless data transmission from the electronic control unit takes place depending on the location of the floor conveyor. For instance, the wireless data transmission can be initiated always when the floor conveyor is in a certain region of a storeroom or in a depot. Preferably, a particularly reliable radio connection is possible at these selectable locations.

According to one embodiment of the present invention, the electronic control unit can initiate a data transmission from the external memory to the memory of the floor conveyor. This permits selective update of the program in the internal data memory, i.e., in that one of the floor conveyor.

In one embodiment of the present invention, the operation-related data comprise data concerning the travel operation and/or data concerning the lifting operation and/or data concerning state variables of the floor conveyor and/or data concerning particular events and/or data concerning merchandise management and/or data concerning persons. Memorising the mentioned data permits a selective and differentiated analysis of the kind and of the extent of the usage of the floor conveyor.

In one embodiment of the present invention, the wireless data transmission device uses a WLAN, GMS, GPRS and/or UMTS network, or any arbitrary other network. When using a WLAN network, a local network can be established which permits large data transfer rates. The mentioned mobile radio networks permit data transmission over large distances in particular.

In one embodiment of the present invention, the electronic control unit is connected to a vehicle data bus of the floor conveyor. Via the vehicle data bus, the electronic control unit can read out different operation-related data of the floor conveyor. In particular, the vehicle data bus can be a so-called CAN-bus (Controller Area Network).

According to one embodiment of the present invention, the electronic control unit, the data memory on the floor conveyor and the wireless data transmission device are realised as a backfittable module. The mentioned components can be accommodated in one common housing. An antenna for the wireless data transmission can optionally be realised separately and can be connected with the module. The module can be equipped with suitable plug-in connectors for the connection with a power supply and for data exchange with the floor conveyor. The module permits simple back fitting of a floor conveyor.

Thus, besides to the already described floor conveyor, a remote maintenance system according to the present invention comprises the additional technical infrastructure for the transmission and central storage of the operation-related data. According to the present invention, to this belongs at least one data analysing unit which can access the external data memory. For instance, the data analysing unit may be a PC, a laptop or a notebook, a PDA, a mobile phone or any other handleable device which provides a user interface. With such a data analysing unit, the operation-related data filed in the external data memory can be analysed. By integrating the external data memory into a corresponding network, the data analysis is possible at arbitrary locations and at arbitrary times.

In one embodiment of the present invention, a plurality of floor conveyors is provided, which each one at a time transmit operation-related data to the external data memory. Thus, the external data memory comprises operation-related data of plural floor conveyors, for instance of the complete vehicle stock of a logistics company. Thus, exhaustive analyses of the complete vehicle stock can optionally be performed via the external data memory.

According to one embodiment of the present invention, the external data memory is integrated into a computer network of the logistics company which uses the floor conveyor. Thus, the external data memory can be accessed immediately from the complete computer network of the logistics company.

In one embodiment, the external data memory is integrated into a computer network of the company which provides the floor conveyor. For instance, this company may be the manufacturer of the floor conveyors or a service firm, which hires out or maintains the floor conveyors, respectively. In both cases, the respective company can access the database immediately. For instance, this permits the manufacturer of the floor conveyor to perform exhaustive technical analyses without negatively affecting the business operation of the floor conveyor's user. For instance, technical innovations of a floor conveyor can be remotely analysed without sumptuous coordination processes with the floor conveyor's user.

For the purpose of data transmission, the send/receive unit in the floor conveyor can also co-operate with a buffer memory, which on its part is designed for the communication with an external data memory. For instance, it is conceivable that a fleet of floor conveyors which are used in a company, a logistics company for instance, communicates with a company related buffer memory via their send/receive units. As explained above, this communication depends on the availability of the transmission link between the individual vehicles with respect to the buffer memory. Then, the buffer memory on its part communicates with a central data memory at another location, wherein this communication can include an own transmission link, a radio link or a wire bound transmission link for instance. For instance, the buffer memories can initiate the transmission to the external main memory. To the reverse, the main memory can also request the buffer memory or a great number of buffer memories in different companies, which each have a buffer memory which on its part communicates with the associated fleet.

According to another embodiment of the present invention, the buffer memory can be provided in a battery charging station, which communicates with a battery which is positioned in the battery charging station for charging purposes. In this case, the operation-related data which are detected in the floor conveyor are transmitted to the memory on the battery, which memory communicates on its part with the buffer memory in the battery charging station. This combination takes preferably place via a wireless link. On its part, the buffer memory adjacent to the battery charging station can then communicate with a main memory at another location, via a radio connection for instance.

In particular, the present invention serves for the remote maintenance of one or plural floor conveyors.

The term “remote maintenance” is not restricted to maintenance works in the narrow sense in this, but it describes all the data captures which can be performed from a remote location, i.e. without direct access to the floor conveyor. Thus, not only the examination of the condition of the floor conveyor with the aid of the operation-related data, but also any other analysis and evaluation of these data is a remote maintenance in the spirit of the present invention.

In one embodiment of the present invention, the user of the data analysing unit can capture data selectively which are necessary for a certain task, while he/she produces a corresponding instruction, which is given up to the external memory via the data analysing unit for instance. By filing the instruction in the external data memory and the subsequent transmission of the instruction to the floor conveyor via the wireless data transmission device, initiated by the vehicle-associated memory or by the control unit, respectively, the instruction is given over to the floor conveyor in a simple manner and making use of the existing infrastructure. Thereafter, the electronic control unit of the floor conveyor accumulates the desired data selectively and files them in the data memory of the floor conveyor. Subsequently, the data are transmitted to the external data memory as already explained, and thus they are at hand for the analysis through the user of the data analysing unit which has given the instruction. Thus, the method permits a selective data capture with a small expense. This is very helpful for error diagnostics and for testing new functionalities of a floor conveyor, when data captured in a standard fashion do not provide sufficient information. In this case, more special data can be captured in a deliberate way.

### BRIEF DESCRIPTION OF THE SEVERAL VIEWS OF THE DRAWINGS

In the following, the present invention is explained in more detail by means of an example of its realisation, represented in figures.

FIG. 1 shows a remote maintenance system of the present invention in a simplified schematic representation,

FIG. 2 shows a remote maintenance module from FIG. 1 for the usage in a floor conveyor, also in a simplified schematic representation,

FIG. 3 shows a modification of the remote maintenance system of FIG. 1,

FIG. 4 shows also a modification of the remote maintenance system of FIG. 1.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

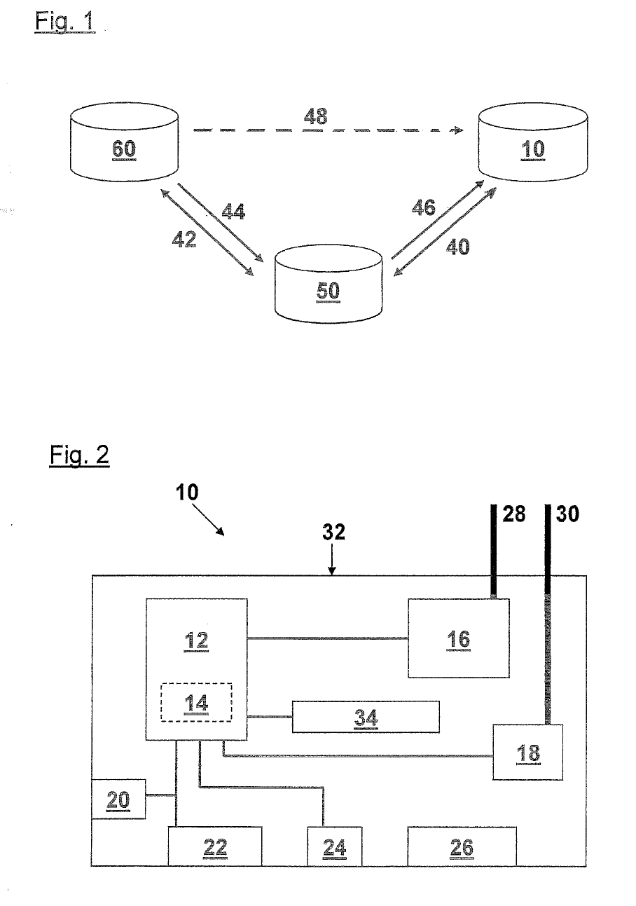

In particular, FIG. 1 serves for the representation of the data transmission between a remote maintenance module 10, an external data memory 50 and a data analysing unit 60. The remote maintenance module 10 is installed in a not shown floor conveyor. It has a data memory 14 and an electronic control unit 12, to which will be incurred later in the context of FIG. 2. The remote maintenance module 10 is further in connection with a not shown apparatus for the capture of operation-related data, or it captures the same itself. Controlled by the electronic control unit 12, these operation-related data are at first stored in the data memory 14 of the remote maintenance module 10, i.e. in the floor conveyor. At points in time presettable by the control unit, there is a wireless transmission 40 of the operation-related data from the data memory 14 of the remote maintenance module 10 to an external data memory 50. A mobile radio network or a WLAN is used for the wireless data transmission 40, for instance. By the periodic wireless data transmission 40, the data in the external data memory 50 are continuously updated.

These data are accessed by the data analysing unit 60, which is constituted by a PC in the example, via a data connection 42. The same may be realised to be wireless also, or even to be wire bound. Thus, the data in the data memory 50 are always at hand for the analysis by the data analysing unit 60, independently from a connection to the remote maintenance module or to the floor conveyor, respectively. In this, the wireless data transmission 40 is initiated by the electronic control unit 12 of the remote maintenance module 10, so that any user interaction is not necessary to keep the data in the data memory 50 up to date. In particular, no manual connection between the floor conveyor and the data memory 50 has to be made manually, no deliberate request of the data from the memory 14 of the remote maintenance module 10 has to be caused by an external side and it is also not necessary to trigger the data transmission manually from out the floor conveyor.

In order to control the kind of the captured data, it is envisioned to produce corresponding instructions at the data analysing unit 60. In the instructions, it can be defined in detail which kinds of data and in which extent or in which frequency, respectively, these data are captured and stored in the floor conveyor. The instructions are transmitted to the external data memory 50 from the data analysing unit 60 as indicated by the arrow 44. In this, they can be addressed to an individual floor conveyor. As soon as the electronic control unit 12 sets up a wireless data transmission 40 to the external data memory 50 the next time, a corresponding instruction present in the data memory 50 is transmitted to the remote maintenance module 10 in the floor conveyor by initiating the control unit 12, as is indicated by the arrow 46. Subsequently, the electronic control unit 12 performs a data capture according to the instruction. After the transmission of the instruction, the same is cancelled in the external memory.

The dashed arrow designated with 48 from the data analysing unit 60 to the remote maintenance module 10 indicates that the electronic control unit 12, triggered by the data analysing unit 60 via a wireless connection for instance, requests an instruction from the memory 50 for instance, which is then transmitted to the module 10.

FIG. 2 schematically shows the assembly of the remote maintenance module 10 from FIG. 1, installed on the floor conveyor. The remote maintenance module 10 comprises an electronic control unit 12 and a data memory 14. The same are combined in a miniature PC in the shown example. As additional, not shown components, the miniature PC can contain a CD or DVD recorder, a read only memory (flash memory) and a working data memory.

The electronic control unit 12 is connected to a mobile radio network modem 16, to which an antenna 28 is connected. Depending on the mobile radio network used, the modem 16 can be an UMTS-, GSM- and/or GPRS modem. In addition, a WLAN module 18 is connected to the electronic control unit 12 via an additional connection. The WLAN module 18 has an antenna 30. The wireless data transmission 40 can be performed optionally with the aid of the modem 16 or with the aid of the WLAN module 18.

As the case may be with the exception of the antennas 28, 30, the already mentioned components of the remote maintenance module 10 are arranged in a common housing 32, which can be attached on or situated in a floor conveyor in a simple manner. The housing 32 has a certain number of plug-in connections 20 to 26, which serve for the connection of additional components. In this, the plug-in connection 20 is a connection possibility for a vehicle data bus, for a CAN-bus for instance. The connections 22 provide a connection possibility for a so-called SAAB plug, which can be used also in connection with a CAN-bus, or alternatively or additionally for the connection of further analog sensors. An Ethernet connection can be produced via the plug-in connection 24. For instance, this permits access to the remote maintenance module 10 via a network cable, for purposes of testing or maintenance for instance. The plug-in connection 26 serves for the connection of a power supply, which provides power for all the components of the remote maintenance module 10.

As is shown, the data memory 50 reacts only when the remote module or the data analysing unit 68, respectively, are acting.

In the represented realisation example, the remote maintenance module 10 contains a display 34, connected to the electronic control unit 12, by which an indication of the state of the remote maintenance module 10 can take place, for instance.

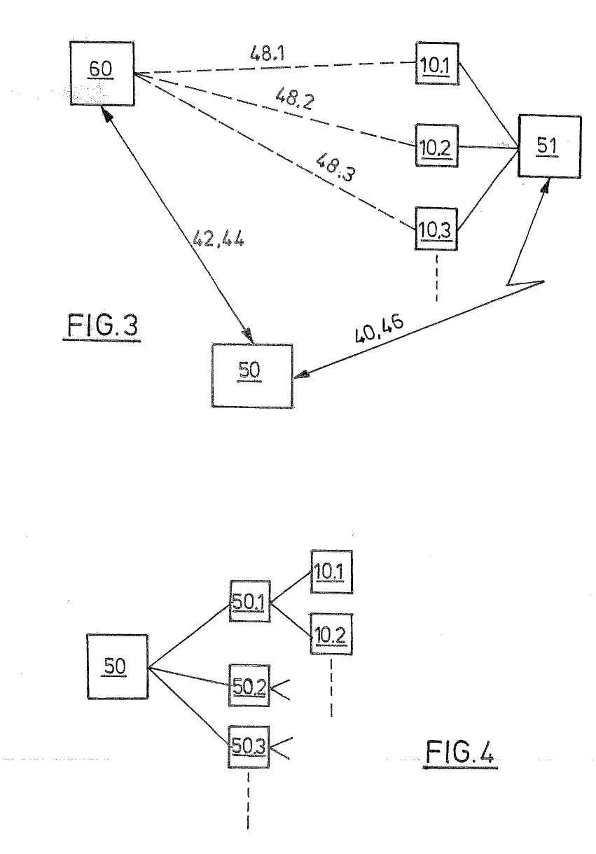

In FIG. 3, it is indicated by 10.1, 10.2 and so on that a plurality of floor conveyors is envisioned, which belong to a fleet in a logistics company, for instance. In the logistics company, a buffer memory can be arranged, with which the remote maintenance modules 10.1, 10.2 and so on communicate. As has been described in detail above, the communication takes place on the initiative of the remote maintenance modules. Via a radio connection for instance, the buffer memory 51 communicates with the external main memory 50. The main memory 50 can communicate with a plurality of buffer memories 51 in different companies.

In FIG. 40, a plurality of buffer memories 50.1, 50.2 and so on is indicated, which communicate with an external main memory in the described manner. The maintenance modules 10.1, 10.2 and so on can each one at a time communicate with one buffer memory 50.1, 50.2 and so on, for instance such that the data memories in the floor conveyors are connected to the battery of the floor conveyor. The buffer memories 50.1, 50.2 and so on are arranged in the charging station for the batteries. As soon as a battery is positioned in the charging station, the individual vehicle's data are transmitted to the buffer memory in the charging station. From the charging station, the communication with the external main memory takes then place in turn, as has been already described. Preferably, the communication between the data memory on the battery and the buffer memory in the charging station takes place via a radio link.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A floor conveyor, with a device for the capture of operation-related data, a data memory, in which the operation-related data can be stored, and an electronic control unit, which controls the capture and the storage of the operation-related data in the data memory, characterised in that the floor conveyor has a data send/receive unit for the transmission of operation-related data from the data memory of the floor conveyor to an external data memory via a transmission link, the control unit has means for checking the availability of the transmission link, and the control unit is designed for the initiation of the data transmission from the data memory to the external data memory.

2. A floor conveyor according to claim 1, characterised in that the data send/receive unit is designed for the transmission via a wireless transmission link.

3. A floor conveyor according to claim 1, characterised in that the initiation of the data transmission can be preformed by the electronic control unit depending on time, depending on event or according to a preset program.

4. A floor conveyor according to claim 1, characterised in that the initiation of the data transmission by the electronic control unit is locus-dependent.

5. A floor conveyor according to claim 1, characterised in that operation-related data comprise data concerning the travel operation and/or data concerning the lifting operation and/or data concerning state variables of the floor conveyor and/or data concerning particular events and/or data concerning merchandise management and/or data concerning persons.

6. A floor conveyor according to claim 1, characterised in that the wireless data transmission link uses a WLAN, GMS, GPRS and/or UMTS network, or other networks.

7. A floor conveyor according to claim 1, characterised in that the electronic control unit is connected to a vehicle data bus of the floor conveyor.

8. A floor conveyor according to claim 1, characterised in that the electronic control unit, the data memory on the floor conveyor and the wireless data transmission device are realised as a backfittable module.

9. A floor conveyor according to claim 1, characterised in that the external memory has a send/receive unit.

10. A floor conveyor according to claim 1, characterised in that the data send/receive unit is designed with a buffer memory for data transmission, which on its part is designed for the communication with an external main memory.

11. A floor conveyor according to claim 1, characterised in that the buffer memory is provided in a battery charging station.

12. A floor conveyor according to claim 1, characterised in that the data memory of the floor conveyor is arranged on the battery of the floor conveyor.

13. A floor conveyor according to claim 1, characterised in that at least one data analysing unit for the access to the external data memory is provided.

14. A floor conveyor according to claim 1, characterised by the application to a plurality of floor conveyors.

15. A floor conveyor according to claim 14, characterised in that the external data memory is integrated into a computer network of a logistics company.

16. A floor conveyor according to claim 1, characterised in that the external data memory is integrated into a computer network of a maintenance company.

17. A floor conveyor according to claim 1, characterised in that the external data memory is designed for the transmission of an instruction to acquire certain operation-related data to the data transmission of the floor conveyor.
